(19) United States
(12) Patent Application Publication
(10) Pub. No.: US 2025/0029043 A1
(43) Pub. Date: Jan. 23, 2025

(54) CONTINUOUS ASYMMETRIC RISK ANALYSIS SYSTEM AND METHOD OF OPERATING THE SAME

(71) Applicant: Incucomm, Inc., Addison, TX (US)

(72) Inventors: Zachry Joseph Engel, Dallas, TX (US); Nickalus Hagen Harrill, Plano, TX (US); Nicolas Velez Camacho, Carrollton, TX (US); Jacob Welker Ediger, Frisco, TX (US); Randal Allen, Orlando, FL (US)

(73) Assignee: Incucomm, Inc., Addison, TX (US)

(21) Appl. No.: 18/779,716

(22) Filed: Jul. 22, 2024

Related U.S. Application Data
(60) Provisional application No. 63/514,661, filed on Jul. 20, 2023.

(51) Int. Cl. G06Q 10/0635; G06N 7/01

(52) U.S. Cl. CPC G06Q 10/0635; G06N 7/01

(57) ABSTRACT

A continuous asymmetric risk analysis system and method of operating the same. In one embodiment, the method includes receiving a definition of a risk event of a complex system based on a likelihood and consequence, and prevention and mitigation measures for the risk event, and receiving risk event data. The method also includes creating a model populated with the risk event data, and executing Monte Carlo simulations of the model to produce Monte Carlo results. The method also includes analyzing and aggregating the Monte Carlo results of the likelihood and consequences, and the prevention and mitigation measures for the risk event to create a nominal risk value of the risk event and asymmetric confidence intervals to produce a continuous gradient of outcomes. The method also includes organizing and presenting the outcomes for evaluation, and prescribing an action for the complex system based on a selected outcome.

### CROSS-REFERENCE TO RELATED APPLICATION

This application claims the benefit of U.S. Provisional Patent Application No. 63/514,661, entitled “Continuous Asymmetric Risk Analysis (CARA)—Overcoming the flaws of the traditional risk matrix,” filed Jul. 20, 2023, which is incorporated herein by reference.

This application is related to U.S. patent application Ser. No. 18/050,661 entitled “System and Method for Adaptive Optimization,” filed Oct. 28, 2022, and U.S. patent application Ser. No. 18/773,333 entitled “Generative Artificial Intelligence System and Method of Operating the Same,” filed Jul. 15, 2024, which are incorporated herein by reference.

### RELATED REFERENCES

Each of the cited references are incorporated herein by reference.

### Nonpatent Literature Documents

Allen, R. (2019). Adaptive Nonconvex Optimization for AI and Machine Learning, I/ITSEC paper 19109.
Allen, R., Engel, Z., Haney, E., (2021), Evolved AI for Model-Based Reinforcement Learning, I/ITSEC paper 21199.
Allen, R., Engel, Z., Volpi, M., (2021), Evolved AI for the Neural Net Enthusiast, I/ITSEC workshop ID9.
Bao, C., Wu, D., Wan, J., Li, J., & Chen, J. (2017). Comparison of different methods to design risk matrices from the perspective of applicability. Procedia Computer Science, 122, 455-462.
Department of Defense Risk Management Guide for Defense Acquisition Programs, 7th ed. 2014. (Interim Release). Washington, D.C.: Office of the Deputy Assistant Secretary of Defense for Systems Engineering.
Elmontsri, M. (2014). Review of the strengths and weaknesses of risk matrices. Journal of Risk Analysis and Crisis Response, 4(1), 49-57. https://doi.org/10.2991/jrarc.2014.4.1.6
Garvey, P. R. and Lansdowne, Z. F. (1998) Risk Matrix: An Approach for Identifying, Assessing, and Ranking Program Risks. Air Force Journal of Logistics, 22, 18-21.
Keelin, Thomas W. (2016) The Metalog Distribution. Decision Analysis, 13(4): 243-277.
Landell, Hanna (2016), The Risk Matrix as a Tool for Risk Analysis (Master's thesis, University of Gavle, Gavle, Sweden). Retrieved from https://www.diva-portal.org/smash/get/diva2:944825/FULLTEXT01.pdf
Lemmens, S. M., Lopes van Balen, V. A., Röselaers, Y. C., Scheepers, H. C., & Spaanderman, M. E. (2022). The risk matrix approach: A helpful tool weighing probability and impact when deciding on preventive and diagnostic interventions. BMC Health Services Research, 22(1). https://doi.org/10.1186/s12913-022-07484-7
Sutherland, H., Recchia, G., Dryhurst, S. and Freeman, A. L. J. (2022), How People Understand Risk Matrices, and How Matrix Design Can Improve their Use: Findings from Randomized Controlled Studies. Risk Analysis, 42: 1023-1041. https://doi.org/10.1111/risa.13822.
Tong, Y. L. (1990). The multivariate normal distribution. Springer Series in Statistics. New York: Springer-Verlag.

### TECHNICAL FIELD

The present disclosure is directed, in general, to risk analysis systems and, more specifically, to a continuous asymmetric risk analysis system and method of operating the same to control complex systems.

### BACKGROUND

Complex systems such as supply chain management, manufacturing operations, training operations, acquisition, test and integration processes, military operations, and intelligence gathering, among others, employ a large number of subsystems that need to be analyzed, designed and controlled. Each subsystem should be properly assessed with an understanding toward the impact on the system as a whole. Although common themes, approaches, and technologies are involved, the simplicity of the present risk analysis systems towards the subsystems and complex systems leads to an incomplete picture that warrants improvement of potential risk. Traditional risk analysis matrices provide a discrete and subjective analysis of the potential risk. It would be beneficial to transform the discrete risk traditional matrix assessing a risk event into a continuous gradient field that eliminates the subjective interpretation of the traditional risk matrix.

### SUMMARY

Deficiencies of the prior art are generally solved or avoided, and technical advantages are generally achieved, by advantageous embodiments of the present disclosure of a continuous asymmetric risk analysis (“CARA”) system and method of operating the same to control complex systems. In one embodiment, the method includes receiving a definition of a risk event of a complex system based on a likelihood and consequence of the risk event, and prevention and mitigation measures for the risk event, and receiving risk event data for the likelihood and consequence of the risk event, and the prevention and mitigation measures for the risk event. The method also includes creating a model populated with the risk event data, and executing Monte Carlo simulations of the model to produce Monte Carlo results based on the risk event data. The method also includes analyzing and aggregating the Monte Carlo results of the likelihood and consequences of the risk event, and the prevention and mitigation measures for the risk event to create a nominal risk value of the risk event and asymmetric confidence intervals around the nominal risk value to produce a continuous gradient of outcomes. The method also includes organizing and presenting the outcomes for evaluation, and prescribing an action for the complex system based on the prevention and mitigation measures for the risk event for a selected outcome.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, reference is now made to the following detailed description taken in conjunction with the accompanying drawings, in which:

FIG. 1 illustrates a graphical representation of a risk assessment matrix;

FIG. 2 illustrates a block diagram of an embodiment of a continuous asymmetric risk analysis (“CARA”) system;

FIG. 3 illustrates a flow chart of an example method of operating a CARA system;

FIG. 4 illustrates a graphical representation of an outcome from the CARA system;

FIG. 5 illustrates a diagram demonstrating a graphical representation of a bowtie analysis;

FIGS. 6 to 9 illustrate graphical representations of outcomes from a CARA system; and

FIG. 10 illustrates a block diagram of an embodiment of an apparatus for operating a CARA system.

Corresponding numerals and symbols in the different figures generally refer to corresponding parts unless otherwise indicated and, in the interest of brevity, may not be described after the first instance.

### DETAILED DESCRIPTION

The Department of Defense (“DoD”) Risk Management Framework was first developed by the Electronics System Center, US Air Force (Garvey and Lindsdowne, 1988) as a method to easily visualize the likelihood and consequence (or impact) of a potential risk. Since the initial development of the risk matrix tool, it has been a mainstay in risk analysis, especially across DoD. Risk matrices have become ubiquitous due to the relative simplicity of creating and explaining them. However, their simplicity also leads to an incomplete picture that warrants improvement.

The risk assessment matrix (also referred to as “risk matrix”) is a common tool used for risk analysis. A traditional risk matrix is built on two factors, namely, the likelihood of a risk event occurring and the severity of its consequences. To measure the likelihood and consequence, the risk matrix uses a 5-point Likert scale for both. A Likert scale is a method of collecting data in which a user selects a value to determine how much a person agrees or disagrees with a statement.

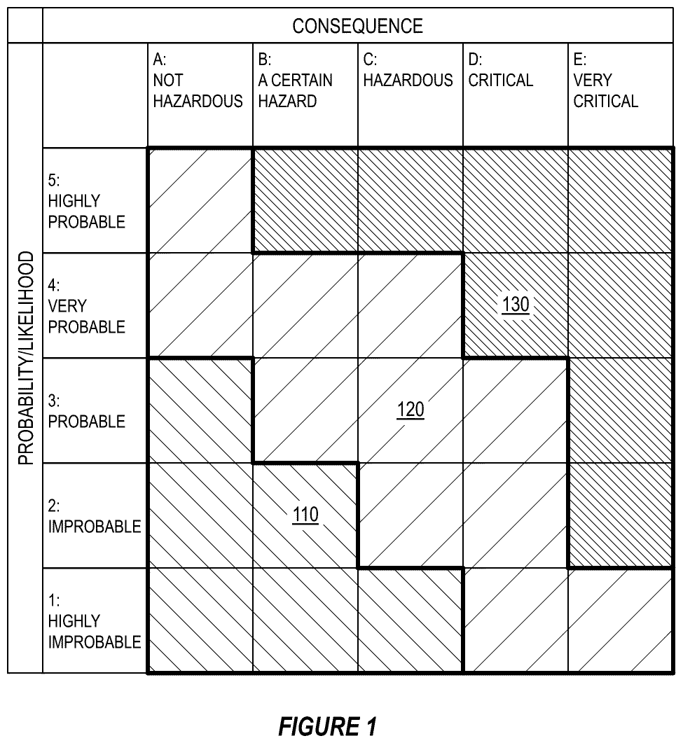

FIG. 1 illustrates a graphical representation of a risk assessment matrix. The risk matrix creates 25 discrete regions by combining the two 5-point Likert scales. The risk matrix is a 5×5 grid with two axes; one axis for the likelihood of a risk event, and one axis for the consequence (or impact) of that risk event occurring. It is shaded grey on the lower left corner (region 110), lighter grey across the diagonal (region 120), and darker grey on the upper right corner (region 130).

Its different shades (which could also be different colors) and discrete nature are easy to understand. However, because the values are discrete, the 25 possible outcomes restrict the information that can be gained from the assessment. For example, if two unrelated risk events map to the same discrete square, this does not mean that these two risk events are equally likely or that they have the same consequences. Furthermore, the risk matrix does not show the variability of potential future risk events.

While these results provide concise and easy-to-understand answers, they do not fully inform the user of the “true risk level” for a given decision due to the discrete nature of its metric. In “What's Wrong with Risk Matrices?” Cox (2008) laid out four main shortcomings with the risk matrices. A first limitation is poor resolution wherein the risk matrix may assign identical risk rankings to multiple risks that are quantitatively different. The second limitation is the risk matrix is subject to errors where the risk matrix may assign higher qualitative ratings to quantitatively smaller risks by mistake. A third limitation is ambiguity where due to the discrete nature of the risk matrix, the interpretation of the severity of the risk is subjective. A fourth limitation is poor resource allocation as the risk matrix does not allow the user to allocate resources to risk-reducing countermeasures.

The continuous asymmetric risk analysis (“CARA”) system disclosed herein addresses the shortcomings of the traditional (or conventional) risk assessment matrices. Like a risk matrix, the CARA system measures the severity of a risk based on its likelihood and consequence of the risk event. However, the CARA system has several advantages over a traditional risk matrix as set forth below. The values of the CARA system for the likelihood and consequence of the risk event are a continuous spectrum instead of discrete values. In other words, the CARA system can select any value within the defined bounds of likelihood and consequence of the risk event, and transform the discrete risk matrix into a continuous gradient field. Instead of a subjective selection of 1 to 5 on a Likert scale as with a traditional risk matrix, the CARA system can select any value from 0 to 100 percent.

The CARA system plots the nominal risk value (also referred to as a “nominal value”), which is based on the median value of the possible likelihood and consequence. The median value of data is the point at which half of the data is less than the median and half the data is greater. The CARA system then generates asymmetric confidence intervals around the nominal point. This allows the CARA system to present both the most likely outcome from the risk event and variable nature of the risk event. The CARA system provides a tool to evaluate the impact on likelihood and consequence of the risk event should a prevention or mitigation measure be added. Prevention measures are taken before the risk event to reduce the likelihood of the risk event occurring and the consequence should the risk event occur. Mitigation measures are taken after the risk event occurs to reduce the consequence of the risk event should it occur. The CARA system allows an operator to evaluate the original risk both with and without any prevention or mitigation measures for analysis of multiple combinations to decide the best strategy to reduce both likelihood and consequence.

Furthermore, in combination with Monte Carlo simulations, the CARA system creates the asymmetric confidence intervals around the median (i.e., nominal) value. In this way, the CARA system can show the possible outcomes of the risk event with more accuracy and in greater detail. By combining any possible combination of likelihood and consequence of outcomes with the asymmetric confidence intervals, the CARA system can account for the median value and the risk's variability, which leads to a more complete decision-analysis tool. Finally, CARA enables operators to consider prevention and mitigation measures to reduce the likelihood and consequence of a potential risk. The CARA system differs from the traditional risk matrix in two key ways; it is continuous rather than discrete, and it contains asymmetric confidence intervals (e.g., asymmetric two-dimensional confidence intervals).

The continuous nature of the CARA system alleviates the restriction and ambiguity inherent in the discrete 25 choices in traditional risk matrices by allowing any number (e.g., infinite) of possible combinations of likelihood and consequence of the risk event (and potential prevention and mitigation measures). Furthermore, by utilizing two-dimensional asymmetric confidence intervals, the CARA system allows operators to evaluate the nominal value of the risk and its potential outcomes. By combining these two advantages, the CARA system shows not only the level likelihood and consequence of the risk event but also a level of variability of the risk event with respect to the outcomes. By using true numerical values to show the variation and the median value, also called the nominal risk value, the CARA system eliminates the subjective interpretation of the traditional risk matrix. Since the traditional risk matrix only allows for 25 discrete values, two points in the same region will be interpreted as having the same risk value unless the operator provides bias or their own subjective interpretation. By producing a range of values rather than a fixed region, the CARA system eliminates the subjective nature of the discrete regions.

Furthermore, the CARA system data collection and simulation avoids the subjective nature of the traditional risk matrix. Typically, in the traditional risk matrix, the decision of where to place the point representing the risk is made by forced consensus or by a single person. Additionally, when the point has been placed, the interpretation of the risk is highly subjective since each block of the risk matrix encompasses four percent of the total risk matrix area. The CARA system avoids the bias of a single person by harnessing the collective input of multiple, equally-weighted subject matter experts. Furthermore, by allowing a continuous gradient of outcomes, the nominal risk value can be objectively interpreted. This objectivity leads to a more succinct and informative risk decision tool.

By using a continuous spectrum of possible values of likelihood and consequence, asymmetric confidence intervals, and evaluating the impact of prevention and mitigation measures, the CARA system resolves the issues cited by Cox. The CARA system overcomes poor resolution by providing a continuous spectrum rather than a discrete matrix. Thus, the risk ratings will only be identical if they are truly identical. If the risk ratings are different, they will appear different. With respect to errors, the CARA system uses the continuous spectrum and asymmetric confidence intervals to show quantitatively which risk is greater. Regarding ambiguity, since the CARA system eliminates the discrete grid in the risk matrix, there is no ambiguity or subjectivity in the interpretation of the risk severity. Concerning poor resource allocation, the CARA system presents the consequence of a prevention or mitigation measure to reduce the risk severity.

The CARA system allows for any number (e.g., infinite) of possible values to measure consequence verses likelihood instead of 25 discrete values. Again, the traditional risk matrix used by the Department of Defense (“DoD”) and others is a 5×5 grid used to measure the likelihood of a risk event occurring and its consequence (or impact) should the risk event occur. This 5×5 grid is typically filled out using Likert scale values for the likelihood and consequence. This tool has been used for decades to evaluate the overall risk of a risk event occurring. However, a major flaw of the risk matrix is its discrete nature which only allows for 25 possible outcomes. This severely reduces the evaluation potential of the risk evaluation since it will not allow for values outside the 25 Provided. Furthermore, by allowing for only these 25 cases, each of which are four percent of the overall available area, it leads to subjective interpretations of the risk being evaluated. If two risks are in the same region in the risk matrix, it is impossible for the user to determine which risk is truly more impactful. It requires the user to make a subjective interpretation of the risk event being evaluated. The simplicity of the traditional risk matrix is both its strength, being easy to understand, and its weakness due to the limitations of only having 25 possible choices.

To solve the issues of the discreteness of the risk matrix, the CARA system instead relies on a continuous field of possible outcomes. This continuity allows the CARA system to employ any value within the range of the CARA system. This allows the CARA system to present an understanding of the risk in a more impactful way than points within a region. By using the CARA system, if two risk events were in the same region as the risk matrix, the CARA system can clearly present which risk event is more likely and/or more consequential. This ability to look at all possible values eliminates the subjective interpretation inherent in the risk matrix. Instead, the CARA system recognizes an objective outcome of the risk statement (a definition of a risk even), which leads to a more informed evaluation of the risk event being considered. It is designed to provide many (e.g., infinite) combinations of likelihood and consequence that more accurately describe the risk associated with the decision in question. Furthermore, by leveraging the use of asymmetric distributions, the CARA system creates confidence intervals around the nominal risk value to provide likely outcomes and their variability.

The CARA system can apply prevention and mitigation measures (or tactics) to evaluate the change in likelihood and consequence of a risk event. Again, a prevention measure is a measure that can be applied before a risk event occurs to reduce the likelihood of the risk event occurring and its consequence should the risk event occur. In other words, a prevention measure is applied to a potential risk to reduce the likelihood (e.g., probability) and consequence of a risk event that could occur. A mitigation measure is a measure that reduces the consequence of the risk event should it occur. In other words, a mitigation measure reduces the consequence of the risk event if it occurs, but they do not reduce the likelihood of the risk event occurring. Similar to the collection of risk event data for likelihood and consequence of the risk event, the CARA system can also collect prevention and mitigation measures using discrete (such as the Likert Scale) and/or continuous values. By investigating both the likelihood and consequence of the risk event along with prevention and mitigation measures, the CARA system can provide a more succinct and informative decision-making tool than the traditional risk matrix.

For example, if we consider the risk event as an injury in a car accident, there are several prevention and mitigation measures that can be applied. There is a baseline assessment of the risk event from the common driving conditions, driver behavior, and vehicle characteristics. One such prevention measure is proper vehicle maintenance. By properly maintaining the vehicle, it is less likely to break down while driving, thus reducing the likelihood of injury due to a car accident, and a properly maintained car is more likely to be structurally sound, thus reducing the injury due to the accident. An example of a mitigation measure would be putting on a seatbelt (prescribing an action). While it does not reduce the likelihood of a vehicle accident, it will reduce the severity of the injuries associated with the accident (the consequence).

The traditional risk matrix allows the evaluation of the likelihood and consequence of a risk event, but does not provide an easy way to apply prevention and/or mitigation measures to the risk event. While a user of the traditional risk matrix can certainly discuss the prevention and mitigation measures, it is not apparent in the risk matrix how much the prevention or mitigation will impact the risk event. For the impact of the prevention or mitigation measure to be seen, it needs to have such a high consequence on the risk statement that it moves the risk statement to a new region in the matrix. While there are some mitigation or prevention measures that will move the risk statement into a new region, this is not always true. Typically, to evaluate the effects of the prevention and mitigation measures, a bowtie analysis could be conducted outside of the risk matrix. A bowtie model is a method for evaluating risk based on its likelihood and consequence of the risk event, prevention measures, and mitigation measures. It is a useful tool to assess the risk of a risk event. However, this analysis is separate from the traditional risk matrix.

The CARA system avoids the shortcomings of the traditional risk matrix with respect to prevention and mitigation measures by combining a bowtie analysis and risk matrix into a single tool. The CARA system collects data for the likelihood and consequence of each prevention and mitigation measure. The consequence of a prevention and mitigation measure is a generally positive one, unlike the consequence of the risk event, which is generally a negative consequence. The prevention measure will affect the likelihood and consequence of the risk event, while the mitigation measure only affects the consequence of the risk event should it occur. The CARA system will evaluate the consequence of each prevention and mitigation measure and show how it affects the risk statement. The CARA system will also calculate and show all possible combinations of the prevention and mitigation measures, including the order in which the prevention and mitigation measures are implemented. By doing so, the operator of the CARA system can see how adding the prevention or mitigation measure will affect the risk event through the outcomes in the form of visual representations such as plots generated from the CARA system.

The CARA system uses asymmetric confidence intervals for more flexibility and the ability to evaluate the variation of the risk event. As mentioned above, the traditional risk matrix only allows the user to place a single point with one of the 25 discrete regions of the risk matrix. Aside from the shortcomings mentioned above, the user of the traditional risk matrix is incapable of evaluating the possible variation of the risk event being studied. While the risk matrix can be applied to past risk events, they are more likely to be applied to future risk events. Although most risk matrices are created using discrete values lie the Likert Scales, most of which are set up in such a way that there is some variation in the selection, the user of the traditional risk matrix is limited in their ability to consider the variation of a future risk event. Furthermore, two risk events in the same region may have a similar likelihood and consequence, one risk event may be more variable than the other.

The CARA system eliminates this inability by creating asymmetric confidence intervals around the nominal risk values. To start, the CARA system plots the nominal risk value that is based on the median value of the possible likelihood and consequence of the risk event. The median value of data is the point at which half of the data is less than the median and half the data is greater than the median. The CARA system then generates asymmetric confidence intervals around the nominal point. A confidence interval refers to the probability that a value will fall between two values a portion of the time based on the confidence interval. For example, a 50 percent confidence interval between 1 and 3 provides an expectation that 50 percent of a similar population in the future will fall between 1 and 3. Once the nominal risk value is calculated, the CARA system creates a 40 percent confidence interval around the nominal risk value for both the likelihood and consequence. In other words, for both likelihood and consequence, the CARA system will pick one point less than the nominal and one greater than the nominal such that 40 percent of similar data will fall between those two points. Then, the CARA system creates an 80 percent confidence interval around the nominal risk value like the creation of the 40 percent confidence interval. These two confidence intervals allow the CARA system to provide an evaluation of the nominal risk value and possible outcomes. By showing both, the operator of the CARA system can determine which risk event is more impactful; the value with a higher nominal risk and less variation, or one with a lower nominal risk value and higher variation.

The CARA system can use Monte Carlo simulations to generate data (Monte Carlo results) from objective data and/or opinions from subject matter experts. The traditional risk matrix can consider the opinion of several subject matter experts (“SMEs”) to place the point within the matrix. However, the placement of the point within the risk matrix is a subjective decision. The user of the traditional risk matrix can do some calculations to consider the final placement of the point, but by the end of the calculations, the final placement of the point is dependent on a final decision maker. For example, if 7 SMEs were polled for the consequence of a risk event and the Likert scale values provided by the SMEs were 1, 1, 4, 4, and 5, where should the user of the risk matrix place the point? Should it be placed in the ‘4’ region since the data leans to the left and that seems like a middle ground? Should it be placed in the ‘3’ region since the average of the data is 3? Should it be placed in the ‘1’ or ‘4’ region since those are the most chosen? These open-ended questions are subject to interpretation from the user and thus creates bias in the system which causes subjectivity.

In combination with the Monte Carlo simulations, the CARA system provides an objective placement of the risk value. The Monte Carlo simulations are a computational algorithm (representations) in which a random sampling of initial conditions repeated many times leads to a numerical result (Monte Carlo results) that can be evaluated to see the likely outcomes over the long run. To leverage the Monte Carlo simulations, the CARA system begins by aggregating all of the input data (also referred to as “risk event data”), regardless of if it comes from SMEs, real data, or the way the data is inputted (i.e., discrete values, continuous values, and/or a (random) spread or distribution of values of data). Once the risk event data is collected, the CARA system will randomly select the input for the likelihood and consequence for a given risk event, prevention measures, and mitigation measures. If the risk event data used in the system was gathered by or polled from SMEs, the CARA system will randomly select the input of each likelihood and consequence of the risk event, and prevention and mitigation measures from potentially different SMEs. For example, if there was a risk event with two possible prevention measures and three possible mitigation measures, and five SMEs were polled using Likert scales to calculate the risk value, the CARA system may collect the risk value by pulling the data from the SMEs as set forth below.
Risk likelihood and consequence of the risk event: SME 2
First prevention measure likelihood and consequence of the risk event: SME 1
Second prevention measure likelihood and consequence of the risk event: SME 3
First mitigation measure likelihood and consequence of the risk event: SME 1
Second mitigation measure likelihood and consequence of the risk event: SME 5
Third mitigation measure likelihood and consequence of the risk event: SME 4

By randomly sampling the risk event data from all SMEs and not evaluating one SME at a time, the CARA system removes the bias of a single SME and instead relies on the wisdom of the aggregate information to create the risk event data. The removal of the bias comes from the risk event data being put into the CARA system that does not know the identity of the SME polled. It will consider the values from all SMEs equally, thus removing a personal bias of the operator. The CARA system will repeat this process many times (e.g., thousands) so it can see what the results looks like in the aggregate. The same process is used for the continuous data inputs (risk event data) that can be entered into the model. After the thousands of Monte Carlo simulations, the CARA system will aggregate the results of the simulations and use those values to create the nominal risk value and the asymmetric confidence intervals. Since the values are calculated through the CARA system, it removes the subjective interpretation of the risk value and provides a concise response.

The CARA system allows for both discrete Likert Scale values, continuous values between any bounds, or distributions (e.g., random distributions) to generate the risk event data. Because of the discrete nature of the traditional risk matrix, which typically allows for five different possibilities for the likelihood of the risk event and five choices for the consequence of the risk event, data is typically entered into the traditional risk matrix using a discrete polling collection.

The CARA system can provide outcomes with two axes, namely, one to represent the likelihood of the risk event occurring and one to represent the consequence (impact) of that risk event should it occur. The two axes are independent of each other. While this may seem counterintuitive, this has been supported by checking the Pearson's correlation coefficient. Since the Pearson correlation coefficient is always approximately zero in the CARA system, there is no correlation between the likelihood and consequence of the risk event, so the CARA system can collect the data for each variable separately without needing to consider the other. The CARA system can also apply the prevention and mitigation measures separately, or in combination.

To collect the data, the CARA system can use Likert scale values or continuous inputs (risk event data). The Likert scale is a five-level psychometric scale that is commonly used for quantitative human analysis but also for the collection of risk matrix data, since the five-level format easily plugs into the standard 5×5 risk matrix. Since the CARA system allows for any values, it can accept the same Likert scale values as the risk matrix. For example, Table 1 shows the typical likelihood criteria used in the Department of Defense Risk Management guide to quantify the likelihood of a risk event.

TABLE 1
Likelihood Criteria

| Level | Likelihood | Probability of Occurrence |
|---|---|---|
| 5 | Near Certainty | >80% to ≤99% |
| 4 | Highly Likely | >60% to ≤80% |
| 3 | Likely | >40% to ≤60% |
| 2 | Low Likelihood | >20% to ≤40% |
| 1 | Not Likely | >1% to ≤20% |

A Likert scale is a method of collecting data in which a user selects a value, usually between one and five, to determine how much a person agrees or disagrees with a statement. TABLE 2 shows the Likert scale values used by the Department of Defense (“DoD”) to calculate the consequence associated with cost, performance, and schedule. While the values in the Likert scale can have some variability, the discrete selection does not fully encompass the variability in a risk assessment.

TABLE 2
Sample Consequence Criteria

| Level | Cost | Schedule | Performance |
|---|---|---|---|
| 5 - Critical | 10 percent (“%”) or | Schedule slip | Degradation precludes |
| Impact | greater increase over | will require a | system from meeting a |
| | acquisition program | major schedule | key performance parameter |
| | baseline (“APB”) | re-baseline | (“KPP”) or key |
| | objective values for | Precludes | technical/supportability |
| | research, development, | program from | threshold; will jeopardize |
| | test & evaluation | meeting its | program success. |
| | (“RDT&E”), | APB schedule | Unable to meet |
| | program acquisition | threshold dates. | mission objectives |
| | unit cost (“PAUC”), or | | |
| | average procurement | | |
| | unit cost (“APUC”) | | |
| | Cost increase causes | | |
| | program to exceed | | |
| | affordability caps. | | |
| 4 - Significant | 5%-<10% increase | Schedule deviations | Degradation impairs |
| Impact | over APB objective | will slip program | ability to meet a key |
| | values for RDT&E, | to within 2 months | system attribute |
| | PAUC, or APUC. | of approved APB | (“KSA”). |
| | Costs exceed life | threshold | 2 Technical design or |
| | cycle ownership | schedule date. | supportability margin |
| | cost KSA. | Schedule slip puts | exhausted in key areas. |
| | | funding at risk. | Significant |
| | | | performance impact |
| | | | affecting system-of |
| | | | system interdependencies. |
| | | | workarounds required |
| | | | to meet mission |
| | | | objectives. |
| 3 - Moderate | 1%-<5% increase | Can meet APB | Unable to meet lower |
| Impact | over APB objective | objective schedule | tier attributes, technical |
| | values for RDT&E, | dates, but other | performance measurements |
| | PAUC, or APUC. | non-APB key events | (“TPMs”), or critical |
| | Manageable with | (e.g., systems | technical parameters |
| | program executive | engineering | (“CTPs”) Design or |
| | office (“PEO”) or | technical reviews | supportability margins |
| | service assistance. | (“SETRs”) or other | reduced. |
| | | tier 1 schedule | Minor performance impact |
| | | events) may slip | affecting system-of system |
| | | schedule slip impacts | interdependencies. |
| | | synchronization with | workarounds required |
| | | interdependent | to achieve mission tasks. |
| | | programs by greater | |
| | | than 2 months. | |
| 2 - Minor | Costs that drive | Some schedule | Reduced technical |
| Impact | unit production | slip, but can | performance or |
| | cost (e.g., APUC) | meet APB | supportability; can |
| | increase of <1% | objective dates | be tolerated with |
| | over budget. | and non-APB | little impact on |
| | Cost increase, | key event dates. | program objectives. |
| | but can be | | Design margins |
| | managed internally. | | reduced, within |
| | | | trade space. |
| 1 - Minimal | Minimal impact. | Minimal schedule | Minimal consequences |
| Impact | Costs expected | impact. | to meeting technical |
| | to meet approved | | performance or |
| | funding levels. | | supportability |
| | | | requirements. |
| | | | Design margins will be |
| | | | met; margin to planned |
| | | | tripwires. |

The CARA system alleviates this issue by allowing for any input of the risk event data to take any value. If the operator of the CARA system wanted to use a Likert scale like the DoD, then the CARA system can handle that information as well. However, the CARA system can also take values that are not discrete. The possible values of the CARA system can represent a Likert scale value (any number from 0-5) or the bounds can be adjusted to any values. For example, if the operator wanted to evaluate the percent likelihood of a risk event occurring, the operator can enter a value like 60 percent, instead of a Likert value of three. This allows for a transparent and objective interpretation of the risk event data. Furthermore, the operator of the CARA system may wish to evaluate the situation in which the risk event data being entered can more accurately be represented by a spread of data, or a distribution. For example, the operator can define the likelihood of the risk event occurring as between 55 and 65 percent. The value selected from these bounds can be selected uniformly, each percentage within the bounds are equally likely to be selected during the evaluation process, or according to a distribution such as the normal distribution. In such a case, the most likely outcome would be around 60 percent and the edges of the range would be less likely to occur. By using this method, the operator is not restricted to the variation in a Likert scale and can instead define their own bounds.

The CARA system operates in real time for quick turnaround to generate the risk matrices. Traditional risk matrices rely on human input to create the matrix. This requirement slows down the production of the risk matrix and increases the subjectivity of the tool. The subjectivity of the traditional risk matrix also means it cannot accept data and automatically generate a risk matrix since human intervention is needed.

An advantage of the CARA system is the speed at which the results (or outcomes) can be generated. Since the traditional risk matrix is a subjective tool that requires human input to place the point on the matrix, it takes more effort to create the risk matrix. Since the CARA system is an objective tool that automatically creates the risk plots based on the risk event data alone, it can generate the plots much faster than traditional tools with human input. The CARA system only requires the data for the likelihood and consequence of the risk event, prevention measures, and mitigation measures to be entered into the system, and the CARA system will automatically generate the outcomes (or results) such as in the form of visual representations (e.g., plots). Furthermore, the CARA system can be set up to accept data in real time and generate plots as new data comes in.

One of the defining features of the CARA system is the two-dimensional confidence interval, which allows operators to visually analyze the variability of a possible risk. While bivariate normal distribution is possible, such a distribution is too symmetrical for the kinds of data being analyzed. For data close to the edges of a CARA plot, a symmetric confidence interval could exceed the bounds of the CARA plot. Furthermore, responses using a Likert scale format or any other discrete polling method are rarely symmetric.

To solve the issues with the bivariate normal distribution, a bivariate asymmetric Gaussian distribution can be employed. By allowing asymmetry with respect to the median, the CARA system can more accurately fit a distribution to data that has asymmetry. To create these distributions, the CARA system can find the median, 10th and 90th percentile values for both likelihood and consequence and fit a quantile-parameterized distribution (“QPD”) to the three values. Of course, finer percentile values can also be used. By combining the two QPDs, the CARA system can create the two-dimensional confidence intervals around the median value. The two asymmetric Gaussian distributions used to create the confidence intervals (one for the likelihood and one for the consequence) are independent of each other, which precludes the need for a covariance matrix. This independence has been tested using the Spearman correlation coefficient, which proved the independence of the two dimensions.

As mentioned above, once the risk event data is collected, regardless of format, the CARA system uses Monte Carlo simulations to generate data (Monte Carlo results) for the asymmetric confidence intervals. By using Monte Carlo simulations, the CARA system can reflect the uncertainty inherent in the decision-making process. The values used in the DoD Likert Scale values all have uncertainty, which can be captured by using Monte Carlo simulations. Furthermore, the use of Monte Carlo simulations allows an investigation of how the prevention and mitigation measures impact the likelihood and consequence of a risk statement of the risk event. Using the Monte Carlo simulations, the CARA system can evaluate thousands of possible scenarios for the potential risk, thus providing more insight into the risk statement of the risk event. The Monte Carlo results of all these possible scenarios are aggregated to create a single CARA system plot. This generated plot is a much more informative risk assessment than a single person deciding where a point belongs on a risk matrix. Although many (e.g., thousands) possible scenarios are evaluated using Monte Carlo simulations, the CARA system aggregates the thousands of trials and condenses them into a single CARA system outcome such in the form of a visual representation (e.g., plot).

The CARA system provides a communication interface such as Microsoft Power Bi tools that allows for easy visual evaluation of possible risk scenarios. A disadvantage of the traditional risk matrix is its inability to consider the reduction in the severity of the risk event after the implementation of a prevention and/or mitigation measure. Risk matrices only show a singular value for the risk statement of the risk event. Therefore, a user of the traditional risk matrix is restricted by only looking at that one value and not how a prevention and/or mitigation measure may affect the risk event.

Since the CARA system can evaluate outcomes (such as in the form of plots) with all possible combinations of the prevention and mitigation steps, many (e.g., thousands) of possible plots can be created through the evaluation of a single risk statement. These plots will show the operator of the CARA system the original risk statement with any combination of its prevention and/or mitigation measures. Since a single risk statement of the risk event may have several preventions and/or mitigation measures, the CARA system could generate thousands of possible strategies (including the prevention and/or mitigation measures) to reduce and/or minimize the risk event. However, by utilizing tools such as Microsoft Power BI tools, the CARA system can organize and display any of these strategies in any order according to the operator's wishes. This allows for the operator to easily evaluate any of these strategies in a concise, easy to understand manner.

The CARA system can be optimized to find the scenarios that cause the lowest risk, the minimal variance, or both. Since the traditional risk matrix is a static tool, unless the user decides to move the point, and does not show the effects of prevention and mitigation measures, the concept of optimization within the traditional risk matrix is not feasible. The CARA system can be optimized to create the optimal strategy to reduce risk based on the evaluation of the likelihood and consequence of the risk event, along with prevention and mitigation measures. Furthermore, by utilizing an optimization algorithm that can consider constraints, such as disclosed in U.S. patent application Ser. No. 18/050,661 (referred to as TruSolve™), the operator of the CARA system can optimize a strategy to reduce the overall risk is several ways.

For example, the operator of the CARA system may wish to find a combination of mitigation and prevention measures that reduce the nominal risk value. However, those mitigation and prevention measures may cost a certain amount of time and/or money to implement. If the operator had a seemingly unlimited budget, then there would be no restriction on the amount of money each measure would cost. Since this is rarely the case, the operator of the CARA system can apply a restriction, or constraint, on the amount of money that can be spent. Similarly, there would be restrictions on the amount of time each measure can take to implement. Subject to these constraints of time and money, the CARA system can find the optimal combination of prevention and mitigation measures to reduce the nominal risk value. Furthermore, the operator of the CARA system can also decide to optimize the risk value subject to the variability from the asymmetric confidence intervals. For example, an operator of the CARA system may be willing to accept a larger nominal risk value if it has lower variability than the strategy with the lower nominal risk value.

This approach is another example of the objective interpretation of risk assessment. When using the traditional risk matrix, there is no quantifiable metric for evaluating the consequence of a prevention and/or mitigation measure, it is a subjective interpretation of the impact. Using an optimization algorithm and quantifiable constraints, the CARA system can evaluate all possible combinations of the prevention and/or mitigation measures and provide an objective evaluation of the optimal strategy.

The CARA system is an alternative to the traditional risk matrix most people involved in risk analysis, especially those in the Department of Defense (“DoD”), use. The CARA system is similar to the traditional risk matrix in that it evaluates the overall risk of a risk event based on its likelihood and consequence of the risk event. Unlike the traditional risk matrix, the CARA system is a continuous field of possible values, as opposed to the 25 discrete options in the risk matrix. The CARA system also introduces asymmetric confidence intervals. By using these asymmetric confidence intervals, the operator of the CARA system can not only look at the nominal risk value, but also the variation on the possible outcomes of the risk statement. The CARA system builds the outcomes including a visual representation such as in the form of plots used for decision-making.

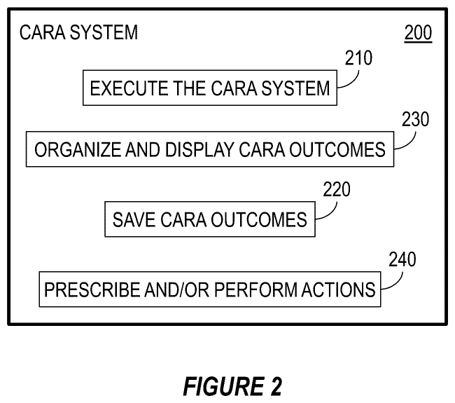

FIG. 2 illustrates a block diagram of an embodiment of a CARA system 200. The CARA system 200 is operable on a processor, memory and communication interface that can create models and processes to perform risk analysis including defining the risk, likelihood and consequence of a risk event, and any prevention or mitigation measures to create outcomes to prescribe and/or perform actions such as to control, implement, design, monitor, operate and/or maintain (maintenance) of complex systems based on selected outcomes. While the disclosure provides examples for CARA system 200 such as workforce management, the concepts herein apply generally to other complex systems such as, without limitation, aerospace vehicle systems, threat analysis, radars and electronic warfare systems, manufacturing, process management, supply chain, condition-based maintenance, financial, organizational reputation, personnel management and processes such as, without limitation, training programs and acquisition programs. Any of the embodiments of the CARA systems disclosed herein are also operable on a processor, memory and communication interface to perform the risk analysis, design, control, implement, operate and/or maintain complex systems.

For instance, the CARA system 200 can evaluate a risk of a subsystem or component of an aerospace vehicle system will fail (risk event), and consequences of the risk event, along with prevention and mitigation measures, and provide outcome(s) (such as in the form of plots) that assess the risk events and provide prescriptive actions to reduce the risk events and implement counter measures to reduce the risk events. As a personnel example, the CARA system 200 can be applied to assess cost, performance, and schedule impacts for a maintenance depot where government employees (a prescriptive action) replace contract labor. As another example, the result of a hypersonic missile threat analysis may be its range capability. To offset this risk, mitigation efforts of the CARA system 200 may be tailored according to the short time available to intercept the missile (a prescriptive action).

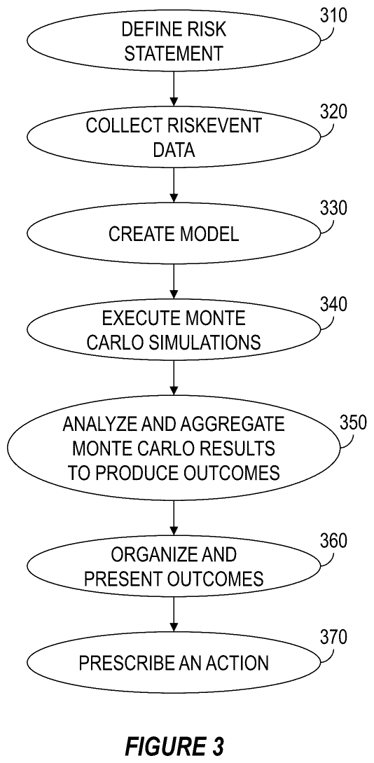

Once a problem (risk statement) is defined and risk event data is collected (received and stored in memory), the CARA system 200 executes 210 on a processor as set forth below. The CARA system 200 creates a model that is populated with the risk event data, and conducts a Monte Carlo simulation(s) to evaluate the risk associated with the risk event being evaluated (Marlo Carlo results). The CARA system 200 analyzes and aggregates all the Monte Carlo results to create a nominal risk value of the risk event and asymmetric confidence intervals around the nominal risk value. In other words, the CARA system 200 builds the asymmetric confidence intervals around the nominal risk value of likelihood and consequence (along with prevention and mitigation measures) to produce a continuous gradient of outcomes including a visual representation such as in the form of plots. The CARA system 200 will then organize all the plots generated into an organizational interface and present (display) the plots via a communication interface 220. The CARA system 200 saves 230 the outcomes (in memory) and other information during execution of the CARA system 200. The CARA system 200 can then prescribe and/or perform actions 240 such as to control, implement, design, monitor, operate and/or maintain (maintenance) complex systems based on selected outcome(s) (via a processor and communication interface). For more details around the operation of the CARA system 200, see discussion below with respect to FIG. 3 and other sections of this disclosure.

FIG. 3 illustrates a flow chart of an example method of operating a CARA system. As mentioned above with respect to FIG. 2, the CARA system is operable on a processor, memory and communication interface that can create models and processes to perform risk analysis including defining the risk, likelihood and consequence of a risk event, and any prevention or mitigation measures to create outcomes to prescribe and/or perform actions such as to control, implement, design, monitor, operate and/or maintain (maintenance) of complex real systems based on selected outcomes. To begin the process of developing the CARA system outcomes such as in the form of plots, the problem (risk statement) is defined in (received and stored in memory) a step or module 310. The CARA system is designed to evaluate the (potential) risk of an event (a risk event) of a complex system based on the likelihood and consequence of the risk event. Once the risk statement is defined, any prevention and/or mitigation measures are defined that may impact the risk event in the step or module 310. A prevention measure is a measure that is applied before the risk event occurs. By doing so, the prevention measure can reduce the likelihood of the risk event occurring and reduce the consequence should the risk event occur. A mitigation measure is a measure that is applied after the risk event has occurred. By applying a mitigation measure, the consequence of the risk event can be reduced.

After the risk event being analyzed and any prevention and mitigation measures that can be applied to the risk statement are defined, the CARA system collects (receives and stores in memory) risk event data about the likelihood of the risk event occurring, the consequences of the risk event, and potentially any prevention and mitigation measures applicable to the risk event in a step or module 320. Traditional risk matrices rely heavily on Likert scales to collect and analyze a risk event. A Likert scale is a method of collecting data in which an operator selects a value, usually between one and five, to determine how much the operator agrees or disagrees with a statement. The traditional risk matrix only allows for these kinds of discrete metrics because the risk statement itself is a discrete 5×5 grid. The CARA system can accept these discrete values, but it can also accept any value. Since the CARA system provides a continuous gradient of outcomes, as opposed to the discrete nature of the traditional risk matrix, the problem can be defined using continuous values. For example, when considering the likelihood of a risk event, the traditional risk matrix can only give an answer such as three, which may represent a 50 percent probability of the risk event occurring whereas the CARA system can define the exact probability of the risk event or give a defined range of possible outcomes. This method allows the CARA system to collect the risk event data in the traditional way like the risk matrix or collect continuous data. The risk event data can be, without limitation, discrete values like Likert scales values, continuous values or distributions (e.g., random distributions). The risk event data can be polled from subject matter experts.

The CARA system creates a model that is populated with the risk event data in a step or module 330 (executed on a processor). The collected risk event data for the risk, prevention and mitigation measures allow the CARA system to create the CARA model. The CARA system will conduct (execute) Monte Carlo simulations of the model to produce Monte Carlo results based on the risk event data to evaluate the risk and consequence of the risk event, and any prevention and mitigation measures, being evaluated in a step or module 340 (executed on a processor). A Monte Carlo analysis is a mathematical technique and general computational approach used to estimate the behavior of complex systems, subsystems or processes. It involves simulating numerous possible scenarios and analyzing their outcomes to gain insights. The Monte Carlo simulations allow the CARA system to generate the points necessary for the asymmetric confidence intervals. It will evaluate many (e.g., thousands) possible scenarios within the Monte Carlo simulations to evaluate the risk more effectively. The Monte Carlo simulations are executed using the risk event data and CARA model to evaluate many (e.g., thousands) results for consideration in the creation of the CARA outcomes including visual representations such as in the form of plots.

After the Monte Carlo simulations have been completed, the CARA system analyzes and aggregates the Monte Carlo results to create a nominal risk value of the risk (a nominal risk value) and asymmetric confidence intervals around the nominal risk value to produce a continuous gradient of outcomes including the visual representations such as in the form of the plots. To do this, the CARA system analyzes and aggregates the outcomes of the likelihood and consequences of the risk event occurring, along with any prevention and mitigation measures, from the Monte Carlo simulations, for instance, separately in a step or module 350 (executed on a processor). It should be understood that the CARA system can provide outcomes that include the likelihood and consequences of the risk event, likelihood and consequences of the risk event with prevention measures, likelihood and consequences of the risk event with mitigation measures, and/or likelihood and consequences of the risk event with prevention and mitigation measures. The prevention measures for the risk event and the mitigation measures for the risk event may be evaluated using a bowties analysis.

For the likelihood of the risk event occurring, the CARA system can take the outcomes from the Monte Carlo simulations and compute, for instance, the 10th, 30th, 50th, 70th, and 90th percentiles of the Monte Carlo simulations. The 50th percentile is used for the nominal risk value since the 50th percentile represents the point at which half of the data is less than that value and half of the data is greater than that value. The 10th, 30th, 70th, and 90th percentiles can be used to create the asymmetric confidence intervals around the nominal risk values. The CARA system can also combine percentile values for both dimensions to create as an example an interior region with a combined confidence interval about the median.

The CARA system then aggregates all of Monte Carlo results of the likelihood and consequences of the risk event, and/or the prevention and/or mitigation measures. In the Monte Carlo simulations, there will be instances where the risk event does not occur. In such cases, the CARA system does not consider the consequences of the risk event since it did not occur. Using this information, similar to likelihood of the risk event occurring, the CARA system finds the 10th, 30th, 50th, 70th, and 90th percentiles for the consequence of the risk event, and/or the prevention and/or mitigation measures. Of course, other percentiles can be used as well. From these Monte Carlo results, the CARA system therefore creates the asymmetric confidence intervals around the nominal risk values of likelihood and consequence of the risk event, and can include any prevention and mitigation measures, to provide the outcomes in the step or module 350 (executed on a processor).

By using the 10th, 30th, 50th, 70th, and 90th percentiles, the CARA system can fit the data to a statistical distribution to create the asymmetric confidence intervals. By splitting the data into a lower half, values less than the nominal risk value, and an upper half, values greater than or equal to the nominal risk value, the CARA system can create confidence intervals around the nominal risk value that are not symmetric. These confidence intervals are generated automatically by the CARA system without the need of human interaction. Furthermore, the CARA system can generate the plots for the risk statement without any prevention or mitigation steps, and the plots with any combination of prevention or mitigation measures. The application of these prevention or mitigation measures can be evaluated in any combination and in any order. By doing so, the CARA system can generate many (e.g., thousands) possible outcomes to evaluate.

Since the CARA system can generate many (e.g., thousands) possible outcomes (stored in memory) for a given risk event, which is more difficult for a human to look at one at a time, the CARA system will then organize all the plots generated into an organizational interface, such as Microsoft Power BI or any other user interfacing organizational tool, and present the plots or a subset thereof (such visual representation (e.g., plot), in a step or module 360 (executed on a processor, stored in memory and displayed on the communication interface). By doing so, the CARA system allows the selection of the risk, prevention, and mitigation measures for a complex system. This interface allows the operator to evaluate all the possible outcomes of the risk event more succinctly and how the prevention and mitigation measures will impact the likelihood and consequence of the risk event. The outcomes can be organized in an order to implement the prevention measures for the risk event and/or the mitigation measures for the risk event. The outcomes also provide a level of variability of the risk event with respect to the outcomes. The CARA system can then prescribe and/or perform actions such as to control, implement, design, monitor, operate and/or maintain (maintenance) complex systems based on selected outcomes in a step or module 380 (via a processor and communication interface).

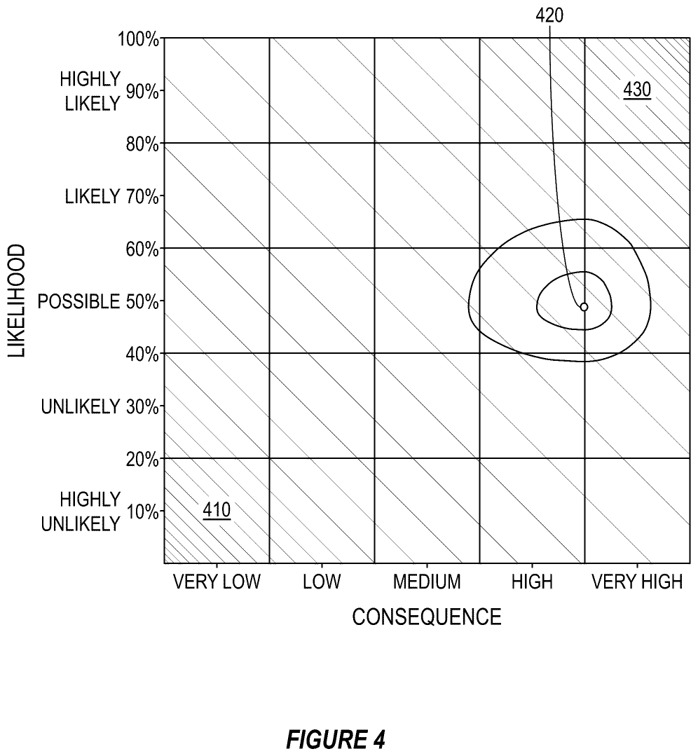

FIG. 4 illustrates a graphical representation (a display) of an outcome (e.g., a visual representation in the form of a plot) from the CARA system. A likelihood of an event in percentage is recorded on the vertical axis and the consequence of the event from very low to very high is recorded on the horizontal axis of the FIGURE. Once the Monte Carlo simulations are completed, the CARA system analyzes and aggregates the Monte Carlo data in order to generate the nominal risk value and the asymmetric confidence interval regions. The grid shown in FIG. 4 does not mean the CARA system plots are discreet. Rather, this grid is intended to suggest the CARA system plots' comparison to the traditional risk matrix. By overlaying a grid over the plot, those who have used the traditional risk matrix are more comfortable with the new tool. Furthermore, the values in the background correspond to shades (or colors) of the risk matrix, except they are gradated to represent continuous values:
The bottom left corner of the plot is a darker grey (region 410, which could be green), representing a risk event with a low level of risk.
The upper right corner of the plot is also a darker grey (region 430, which could be red), representing risk events with a higher degree of risk.
The white dot (designated 420) located inside the two asymmetric boundaries represents the nominal risk value of the risk statement, which is calculated by finding the median value of likelihood and consequence.

To find the two asymmetric bounds in this example, the CARA system can find the 10th, 30th, 70th, and 90th percentile values for the likelihood and consequence based on the results of the Monte Carlo iterations. Of course, other percentile values can be used as well and the prevention and mitigation measures can be included as well. By combining the 30th and 70th percentile values for both dimensions, the CARA system creates the interior region, which represents the 40 percent confidence interval about the median. Similarly, the CARA system can create the 80 percent confidence interval about the nominal risk value by combining the 10th and 90th percentile for both dimensions. By showing the confidence intervals and the nominal risk value (e.g., a median value), the CARA system operators can see the most likely value and the variation around that value.

A purpose of the CARA system is to evaluate risk in a similar (and compatible) manner as the current protocol used by the DoD. However, an objective of the CARA system is to create a decision-making tool for risk analysis that is more informative, objective, and flexible than the traditional risk matrix approach. For example, the CARA system can also be applied as a visual representation of a bowtie analysis.

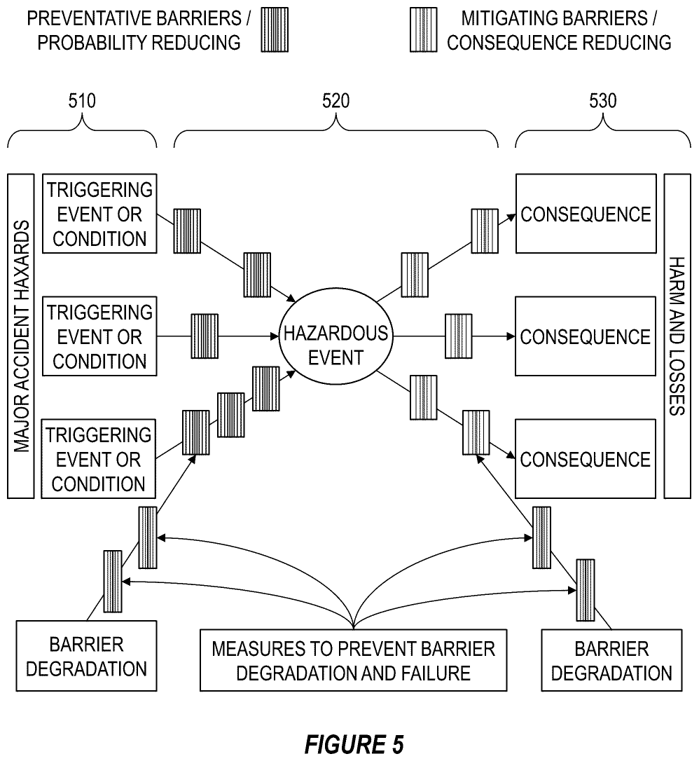

FIG. 5 illustrates a diagram demonstrating a graphical representation of a bowtie analysis. A bowtie model is used to assess the likelihood and consequence of a risk event while taking prevention and mitigation measures into consideration. Working from left to right, the bowtie model starts by analyzing a possible risk event (major accidental hazards 510). Then, prevention measures are introduced to evaluate the reduction in the likelihood of a risk event occurring. The likelihood and consequence of the risk event is then analyzed. After the initial evaluation of the consequence of the risk event, a bowtie model will then apply prevention and mitigation measures 520 to reduce the consequence of the risk event should the risk event occur. Finally, the overall likelihood and consequence of the risk event 530 is calculated.

The CARA system accomplishes this similar methodology to evaluate the risk level of a possible risk event. In additional to the bowtie modeling, the CARA system provides a visual representation of the risk's likelihood and consequence instead of just raw numbers, though those numbers are readily available. This provides a more easily digestible risk analysis tool than the bowtie model. Furthermore, the CARA system can analyze all possible combinations of prevention and mitigation measures in any order the operator desires. The CARA system leverages communication interface tools such as Microsoft Power BI tools, enabling a user-friendly customer interface that facilitates real-time “what-if” scenario generation. Along with this, the CARA system provides the capability to filter through a comprehensive list of risk preventative measures and risk mitigation measures or strategies. Outcomes are delivered as comprehensive clouds of uncertainty (both likelihood and consequence of the risk event) plotted on an integrative risk reporting matrix.

To demonstrate the capabilities of the CARA system, a risk analysis study was conducted for workforce management of a company to evaluate the risk associated with a transition from a direct to organic workforce. Like the DoD risk analysis outline in the Risk Management Guide, the risks associated with cost, performance, and schedule were evaluated while considering possible prevention and mitigation measures for each risk event along with the likelihood of the risk event. This evaluation was used to determine the risk associated with transitioning to new employees, which in turn was used to decide if the benefits of a new workforce outweighed the inherent risk of a full workforce transition.

To accomplish this, over forty possible risks corresponding to cost, performance, or schedule were evaluated along with possible prevention and mitigation measures (or strategies). To collect the data, multiple subject matter experts (“SMEs”) with over 200 years of combined experience in the field were polled using a five-point Likert scale. All SMEs were asked to give their professional opinion on:
The likelihood of a risk event occurring.
The likelihood of a prevention and/or mitigation measures being applied to the risk assessment.
How that prevention and/or mitigation measures would reduce the likelihood or consequence of the risk event.

While a degree of bias is inherent in any polling-based data collection, the CARA system reduces this bias by considering many (e.g., thousands) combinations of different SMEs' input, each of which is valued equally. Furthermore, the CARA system does not evaluate a scenario based on one SME's assessment; rather, it takes the opinion of different SMEs for each risk, prevention measure, and mitigation measure and then aggregates the combined responses. Once the data was collected, the Monte Carlo simulations are executed to evaluate the risk of each risk statement. Over 5,000 possible strategies were evaluated for the risk assessment. Once all the risks were evaluated, the plots organized such that any combination of risks, prevention and mitigation measures could be evaluated.

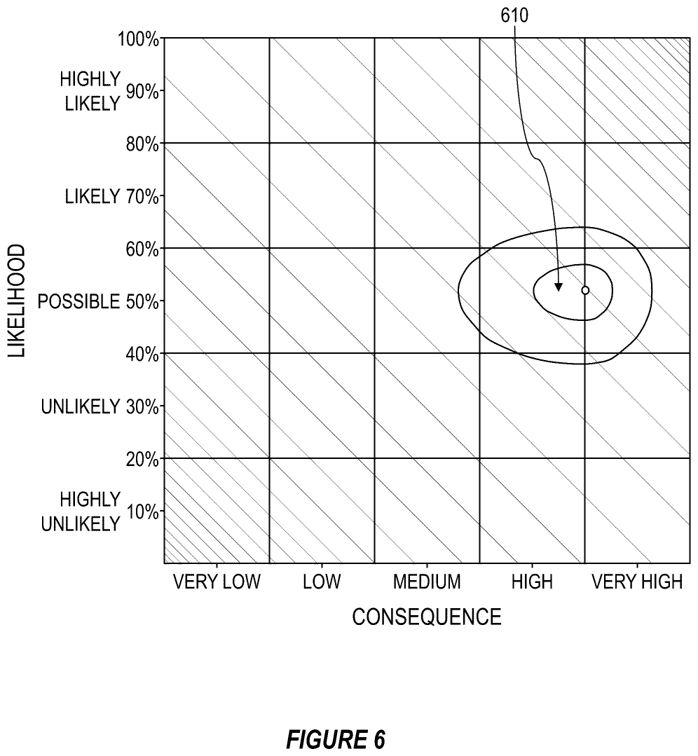

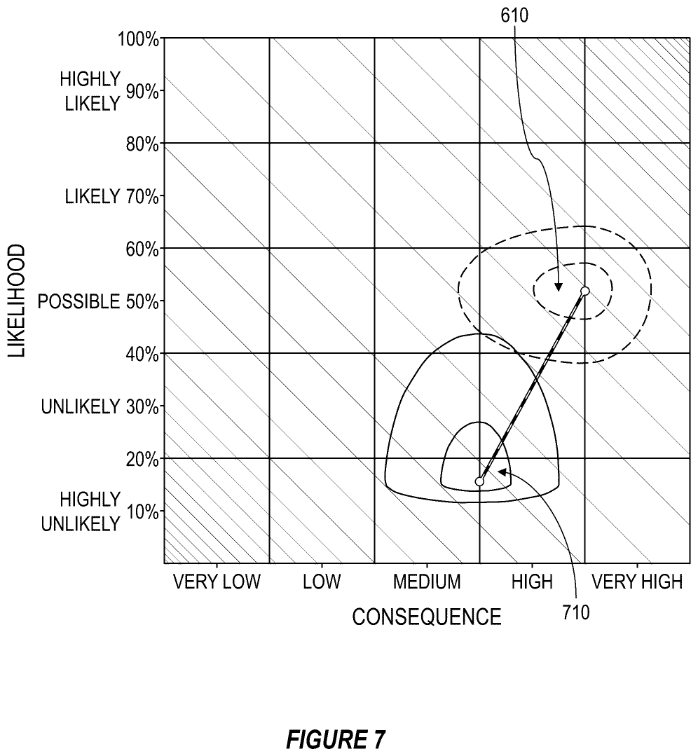

FIGS. 6 to 9 illustrate graphical representations of outcomes (e.g., visual representations in the form of plots) from a CARA system. The outcomes from the CARA system may represent a workforce transition analysis. A likelihood of a risk event in percentage is recorded on the vertical axis and the consequence of the risk event from very low to very high is recorded on the horizontal axis of the FIGUREs. FIG. 6 provides an initial risk statement showing the probability, likelihood, and variation of the risk event with no prevention or mitigation measures applied. The initial risk event likelihood, consequence and asymmetric confidence interval is displayed in region 610 of the plot. FIG. 7 provides an initial risk statement showing the probability, likelihood, and variation of the risk event with no prevention or mitigation measures applied (in region 610 of the plot) and a second outcome showing the application of a single prevention measure. The second risk event likelihood, consequence, and asymmetric confidence intervals after a single prevention measure is applied is displayed in region 710 of the plot.

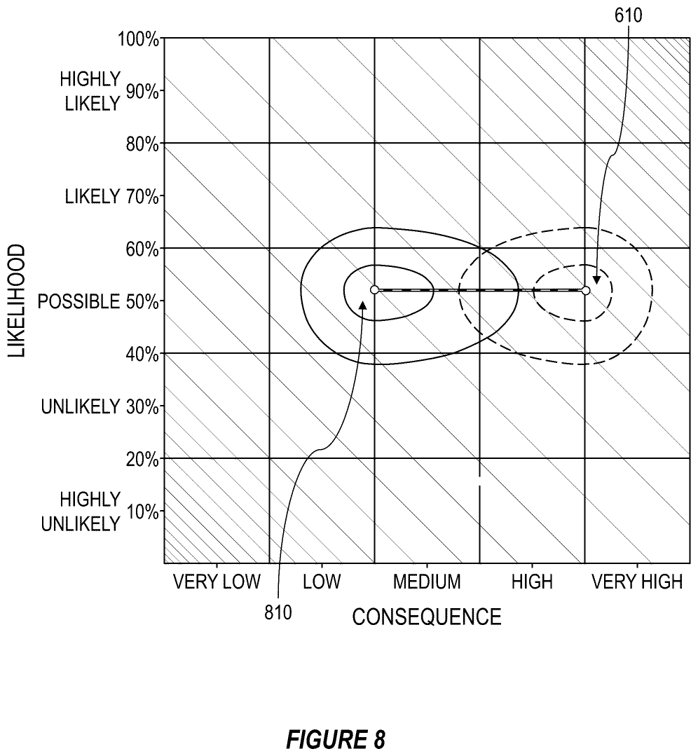

FIG. 8 provides an initial risk statement showing the probability, likelihood, and variation of the risk event with no prevention or mitigation measures applied (in region 610 of the plot) and a third outcome showing the application of single mitigation measure. The third risk event likelihood, consequence, and asymmetric confidence intervals after single mitigation measure is applied is displayed in region 810 of the plot.

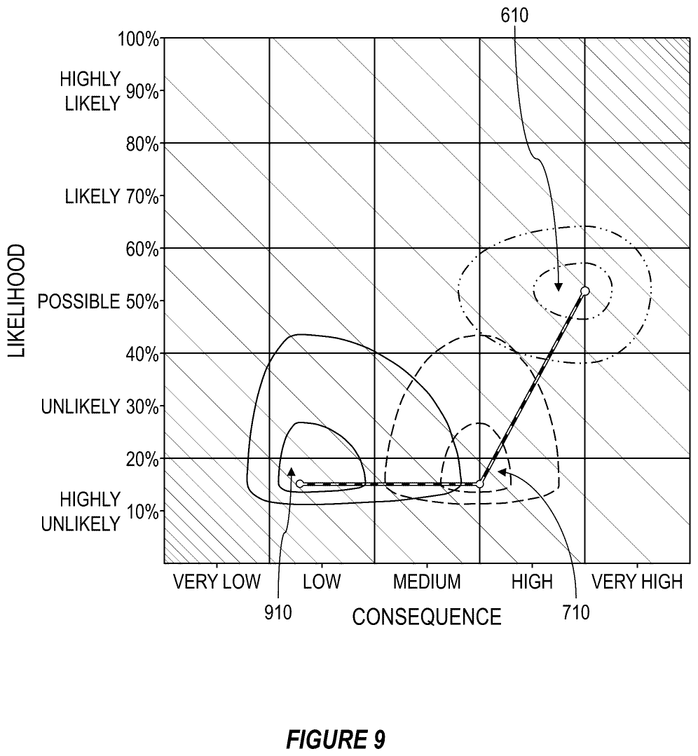

FIG. 9 provides an initial risk statement showing the probability, likelihood, and variation of the risk event with no prevention or mitigation measures applied (in region 610 of the plot) and a second outcome showing the application of a single prevention measure (in region 710 of the plot). In addition, FIG. 9 provides a fourth outcome with the combination of the same prevention and mitigation measures from FIGS. 7 and 8. The fourth risk event likelihood, consequence, and asymmetric confidence intervals after the prevention and mitigation measures are applied is displayed in region 910 of the plot.

As evident from FIGS. 6 to 9, the values of the likelihood and consequence change when a prevention and/or mitigation measure is applied to the initial risk statement. Using these plots, the operator of the CARA system can quickly visually analyze risks and how preventions and mitigations can change the values. Furthermore, the CARA system retains the previous risks and shows how they change when new measures are applied to the risk statement. As more prevention and/or mitigation measures are applied, the previous steps will slowly fade away into the background, so the operator of the CARA system can clearly see the most recent step but also reference previous steps as needed.

FIG. 7 clearly shows a reduction in both likelihood and consequence of the risk event when a prevention measure is applied. In FIG. 8, only consequence is reduced when a mitigation measure is applied. However, in both cases, it is evident that the application of a prevention and mitigation measures increase the variability of likelihood and consequence of the risk event in question, even as it reduces the nominal values of the risk (the nominal risk value). By examining the possible outcomes, the operator can decide if the reduction in the nominal risk value is acceptable given the increase of the variation.

The CARA system is an easily understandable alternative to the traditional risk analysis matrix, and it offers clear advantages due to its continuous nature. Furthermore, the CARA system accepts discrete data (such as Likert scale values), continuous data and/or distributions of data, and it allows for a clear visual analysis of a bowtie model. By leveraging the use of Monte Carlo simulations, the CARA system can show the nominal risk value and asymmetric confidence intervals around the nominal risk value, both of which are unique approaches that demonstrate clear advantages over the current risk matrix.

By considering many (e.g., thousands) possible scenarios (through using of Monte Carlo simulations and evaluating all possible combinations of risks with preventions and mitigation measures), the CARA system provides an in-depth decision analysis. The CARA system operators can evaluate all risks and select a scenario that reduces the nominal value of the risk and its variation. By being able to see all possible combinations of the preventions and mitigation measures, operators can consider the time, effort, and money required and select the optimal strategy for their situation.

Through all these calculations, the CARA system makes risk management easier to perform, more objective, and more easily defendable. By allowing for any value in the continuous gradient, as opposed to the discrete matrix traditionally used, the CARA system removes the subjectivity of interpretations inherent in the traditional risk matrix. Additionally, the CARA system removes most polling bias through Monte Carlo simulations and an aggregation of multiple SME inputs (risk event data). By showing the operator of the CARA system not only a nominal value of the risk, but also asymmetric confidence intervals to show the likely outcomes of the risk, the operator of the CARA system can also consider the variability of the risk event. Through all of these advantages, the CARA system leads to more confident, accurate and objective risk analysis.

A key disadvantage of bowtie analysis models is their static nature. Bowtie analyses are based on the current projection of the likelihood and consequence of the risk event as well as the effect of a prevention and/or mitigation measures. Most bowtie analysis are used to predict the impact of future risk events, which by their very nature are constantly changing. A real-time implementation of the CARA system can help address this issue. By accepting real-time data and by dynamically updating the effects of the consequence, prevention and mitigation measures, and the likelihood of the risk event, the CARA system circumvents this issue. For example, if the CARA system evaluates the risk of a war occurring, the likelihood and consequence of that war occurring is constantly changing based on current global risk events. Furthermore, the possible prevention and mitigation measures that can be implemented to reduce the likelihood and consequence of the war will change along with current technologies, strategies, leaderships, geopolitical atmospheres, and more. Complex future risk events like these would be much easier to evaluate and respond to with a graphical representation of the CARA system analysis that updates in real-time.

In conjunction with a real-time implementation, the CARA system could be even more effective if it were integrated with artificial intelligence (“AI”). By using AI (see, e.g., U.S. patent application Ser. No. 18/773,333), the CARA system could learn and apply the risk preferences of its users. For example, does the user prefer a lower nominal value of risk with a high degree of uncertainty, or does the user prefer a higher nominal values of risk with a low degree of uncertainty. Furthermore, based on the information that the artificial intelligence learns about the operator, it could optimize a strategy based on factors such as cost, time, nominal risk values, and variability of the risk.

As previously mentioned, the CARA system uses an asymmetric Gaussian distribution to generate the confidence intervals around the median value of the risk (the nominal risk value). However, the use of other distributions to create these confidence intervals is within the scope of this disclosure. By using other distributions, the CARA system may be able to create asymmetric confidence intervals that model the data accurately. One such distribution is a metalog distribution (Keelin, 2016). The metalog distribution is a continuous probability distribution that allows for bounded, unbounded, and semi-bounded distributions with virtually unlimited shape flexibility. Like a Taylor series, the metalog distribution can be fit to almost any dataset by using as many terms as necessary to fit the data.

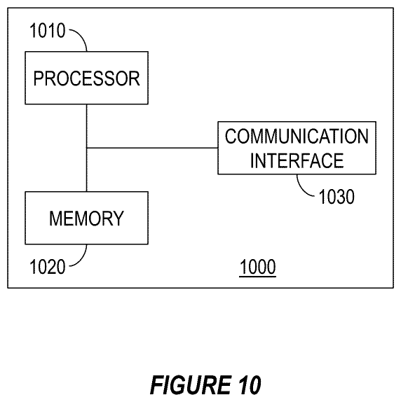

FIG. 10 illustrates a block diagram of an embodiment of an apparatus 1000 for operating a CARA system. The apparatus 1000 is configured to perform functions described hereinabove for the CARA system. The apparatus 1000 includes a processor (or processing circuitry) 1010, a memory 1020 and a communication interface 1030 such as a graphical user interface. The apparatus 1000 operates the CARA system to create models and processes to perform risk analysis including defining the risk, likelihood and consequence of a risk event, and any prevention or mitigation measures to create outcomes to prescribe and/or perform actions such as to control, implement, design, monitor, operate and/or maintain (maintenance) of complex systems based on selected outcomes.

The functionality of the apparatus 1000 may be provided by the processor 1010 executing instructions stored on a computer-readable medium, such as the memory 1020 shown in FIG. 10. Alternative embodiments of the apparatus 1000 may include additional components (such as the interfaces, devices and circuits) beyond those shown in FIG. 10 that may be responsible for providing certain aspects of the device's functionality, including any of the functionality to support the solution described herein.

The processor 1010 (or processors), which may be implemented with one or a plurality of processing devices, perform functions associated with its operation including, without limitation, performing the operations of the CARA system. The processor 1010 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The processor 1010 may include, without limitation, application processing circuitry. In some embodiments, the application processing circuitry may be on separate chipsets. In alternative embodiments, part or all of the application processing circuitry may be combined into one chipset, and other application circuitry may be on a separate chipset. In still alternative embodiments, part or all of the application processing circuitry may be on the same chipset, and other application processing circuitry may be on a separate chipset. In yet other alternative embodiments, part or all of the application processing circuitry may be combined in the same chipset.

The memory 1020 (or memories) may be one or more memories and of any type suitable to the local application environment, and may be implemented using any suitable volatile or nonvolatile data storage technology such as a semiconductor-based memory device, a magnetic memory device and system, an optical memory device and system, fixed memory and removable memory. The programs stored in the memory 1020 may include program instructions or computer program code that, when executed by an associated processor, enable the respective device 1000 to perform its intended tasks. Of course, the memory 1020 may form a data buffer for data transmitted to and from the same. Exemplary embodiments of the system, subsystems, and modules as described herein may be implemented, at least in part, by computer software executable by the processor 1010, or by hardware, or by combinations thereof.

The communication interface 1030 modulates information for transmission by the respective apparatus 1000 to another apparatus. The respective communication interface 1030 is also configured to receive information from another processor for further processing. The communication interface 1030 can support duplex operation for the respective other processor 1010.

As described above, the exemplary embodiments provide both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1. A method of operating a continuous asymmetric risk analysis system on a processor and memory, comprising:
receiving a definition of a risk event of a complex system based on a likelihood of said risk event, consequences of said risk event, prevention measures for said risk event, and mitigation measures for said risk event;
receiving risk event data for said likelihood of said risk event, said consequences of said risk event, said prevention measures for said risk event, and said mitigation measures for said risk event;
creating a model populated with said risk event data;
executing Monte Carlo simulations of said model to produce Monte Carlo results based on said risk event data;
analyzing and aggregating said Monte Carlo results of said likelihood of said risk event, said consequences of said risk event, said prevention measures for said risk event, and said mitigation measures for said risk event to create a nominal risk value of said risk event and asymmetric confidence intervals around said nominal risk value to produce a continuous gradient of outcomes;
organizing and presenting said outcomes for evaluation; and
prescribing an action for said complex system based on said prevention measures for said risk event and said mitigation measures for said risk event for a selected outcome.

2. The method as recited in claim 1 wherein said risk event data are discrete values, continuous values and/or a random distribution of values.

3. The method as recited in claim 1 wherein said risk event data is polled from subject matter experts.

4. The method as recited in claim 1 wherein said prevention measures reduce said likelihood of the risk event and said consequences of said risk event.

5. The method as recited in claim 1 wherein said mitigation measures reduce said consequences of said risk event.

6. The method as recited in claim 1 wherein said analyzing and aggregating comprises analyzing and aggregating said Monte Carlo results of said likelihood of said risk event, said consequences of said risk event, said prevention measures for said risk event, and said mitigation measures for said risk event separately.

7. The method as recited in claim 1 wherein said analyzing and aggregating comprises performing a bowtie analysis to evaluate said prevention measures for said risk event and said mitigation measures for said risk event.

8. The method as recited in claim 1 wherein said outcomes comprise an order to implement said prevention measures for said risk event and said mitigation measures for said risk event.

9. The method as recited in claim 1 wherein said outcomes comprise visual representations of said outcomes.

10. The method as recited in claim 1 of said outcomes provide a level of variability of said risk event with respect to said outcomes.

11. A continuous asymmetric risk analysis system operable on a processor and memory, configured to:
receive a definition of a risk event of a complex system based on a likelihood of said risk event, consequences of said risk event, prevention measures for said risk event, and mitigation measures for said risk event;
receive risk event data for said likelihood of said risk event, said consequences of said risk event, said prevention measures for said risk event, and said mitigation measures for said risk event;
create a model populated with said risk event data;
execute Monte Carlo simulations of said model to produce Monte Carlo results based on said risk event data;
analyze and aggregate said Monte Carlo results of said likelihood of said risk event, said consequences of said risk event, said prevention measures for said risk event, and said mitigation measures for said risk event to create a nominal risk value of said risk event and asymmetric confidence intervals around said nominal risk value to produce a continuous gradient of outcomes;
organize and present said outcomes for evaluation; and
prescribe an action for said complex system based on said prevention measures for said risk event and said mitigation measures for said risk event for a selected outcome.

12. The continuous asymmetric risk analysis system as recited in claim 11 wherein said risk event data are discrete values, continuous values and/or a random distribution of values.

13. The continuous asymmetric risk analysis system as recited in claim 11 wherein said risk event data is polled from subject matter experts.

14. The continuous asymmetric risk analysis system as recited in claim 11 wherein said prevention measures reduce said likelihood of the risk event and said consequences of said risk event.

15. The continuous asymmetric risk analysis system as recited in claim 11 wherein said mitigation measures reduce said consequences of said risk event.

16. The continuous asymmetric risk analysis system as recited in claim 11 wherein said continuous asymmetric risk analysis system is configured to analyze and aggregate said Monte Carlo results of said likelihood of said risk event, said consequences of said risk event, said prevention measures for said risk event, and said mitigation measures for said risk event separately.

17. The continuous asymmetric risk analysis system as recited in claim 11 wherein said continuous asymmetric risk analysis system is configured to perform a bowtie analysis to evaluate said prevention measures for said risk event and said mitigation measures for said risk event.

18. The continuous asymmetric risk analysis system as recited in claim 11 wherein said outcomes comprise an order to implement said prevention measures for said risk event and said mitigation measures for said risk event.

19. The continuous asymmetric risk analysis system as recited in claim 11 wherein said outcomes comprise visual representations of said outcomes.

20. The continuous asymmetric risk analysis system as recited in claim 11 wherein said outcomes provide a level of variability of said risk event with respect to said outcomes.
